(19) United States
(12) Patent Application Publication
(10) Pub. No.: US 2022/0179922 A1
(43) Pub. Date: Jun. 9, 2022

(54) SYSTEM IDENTIFICATION DEVICE, NON-TRANSITORY COMPUTER READABLE MEDIUM, AND SYSTEM IDENTIFICATION METHOD

(71) Applicant: NEC Corporation, Minato-ku, Tokyo (JP)

(72) Inventor: Alexander VIEHWEIDER, Tokyo (JP)

(73) Assignee: NEC Corporation, Minato-ku, Tokyo (JP)

(21) Appl. No.: 17/437,624

(22) PCT Filed: Mar. 19, 2019
(86) PCT No.: PCT/JP2019/011586

§ 371 Date: Sep. 9, 2021

(51) Int. Cl. G06F 17/16; G06F 17/17

(52) U.S. Cl. CPC G06F 17/16; G06F 17/175

(57) ABSTRACT

A data acquisition unit acquires input data and output data of a system to be identified. A memory unit stores initial binary/ternary structure matrices obtained from prior knowledge. A binary/ternary structure matrix generation unit reads the initial binary matrices from the memory unit and generates a plurality of sets of candidate binary matrices. A binary structure matrix selection unit selects one set of binary matrices from the sets of candidate binary matrices. A determination unit determines matrices used in a state equation for the system to be identified and matrices used in an output equation for the system to be identified in response to the selected set of binary matrices. An evaluation unit evaluates whether the determined matrices are reasonable for identifying the system to be identified.

### TECHNICAL FIELD

The present invention relates to a system identification device, a non-transitory computer readable medium, and a system identification method.

### BACKGROUND ART

Various technologies have been used for identifying a system (plant) for control purposes related to control of a building and a factory plant, etc.

Patent Literature 1 (PTL1) discloses a process controller using a PID (Proportional-Integral-Differential) controller. The process controller achieves optimum control under a certain limit at all times by identifying characteristics of a controlled system which changes in the characteristics during its operation, learning the identification result by operation points and environmental conditions, and utilizing the learning result. The process controller is equipped with an identification part, a neural network part, and a control arithmetic unit. The identification part holds and controls inputs and outputs and measurement data in a certain period by assuming a structure of a model representing dynamics between the input and output of a controlled system, and identifies a parameter of the model from those data and outputs its value. When the identification is successful, the neural network unit holds, manages, and learns a state value of the controlled system and the parameter value of the identified model in the state each time they are obtained. Then, the neural network unit regularly determines and outputs the parameter value of the identified model corresponding to the current state value of the controlled system. The control arithmetic unit calculates a best manipulation variable under a predetermined rule from the parameter from a target value for the controlled system, the output value, and the parameter value of the model of the identification result, and supplies the calculated value to the controlled system.

Patent Literature 2 (PTL2) discloses a plant model constructing apparatus for various plants. The plant model constructing apparatus, even if there are changes to the configuration of a plant, having a plurality of plant facilities and plant equipment positioned in each of the plant facilities, can deal with the changes by constructing a desired plant model according to the changes to the configuration of the plant. The apparatus for constructing a plant model includes a monitor for displaying a plant, having a plurality of plant facilities and plant equipment and a plant configuration setting means for setting the desired configuration, by creating or correcting the configuration of the plant facilities and the plant equipment displayed on the monitor. Connection information analyzing means conducts analysis to see whether the set configuration is appropriate for constructing the plant model. A plant model construction means constructs a plant model, by selecting the characteristic equation of the plant equipment according to the configuration analyzed to be appropriate.

### CITATION LIST

### Patent Literature

PTL 1: Japanese unexamined patent publication No. H5(1993)-11805
PTL 2: Japanese unexamined patent publication No. 2006-72637

### SUMMARY OF INVENTION

### Technical Problem

It is desirable that previous knowledge such as past data, user's experience and different users' assumptions on the system structure are integrated in order to improve a quality of system identification. Besides that, it is desirable that identification execution is very fast. However, PTLs 1 and 2 cannot reflect such previous knowledge in the system identification and execution speed may not be fast.

The present invention has been made in view of the above-mentioned problem, and an objective of the present invention is to achieve system identification using previous knowledge.

### Solution to Problem

An aspect of the present invention is a system identification device; including: a structure matrix generation unit configured to read initial structure matrices obtained from prior knowledge and generate a plurality of sets of candidate structure matrices, the initial structure matrices being binary or ternary matrices; a matrix selection unit configured to select one set of matrices from the sets of candidate structure matrices; a determination unit configured to determine matrices used in a state equation for a system to be identified and matrices used in an output equation for the system to be identified in response to the selected set of structure matrices; and an evaluation unit configured to evaluate whether the selected system matrices and therefore also the associated structure matrices are reasonable for identifying the system to be identified.

An aspect of the present invention is a non-transitory computer readable medium storing a system identification program, the system identification program causing a computer to execute: a process of reading initial structure matrices obtained from prior knowledge and generating a plurality of sets of candidate structure matrices, the initial structure matrices being binary or ternary matrices; a process of selecting one set of matrices from the sets of candidate structure matrices; a process of determining structure matrices used in a state equation for the system to be identified and matrices used in an output equation for a system to be identified in response to the selected set of matrices; and a process of evaluating whether the selected structure matrices are reasonable for identifying the system to be identified.

An aspect of the present invention is a system identification method including: reading initial structure matrices obtained from prior knowledge and generating a plurality of sets of candidate matrices, the initial structure matrices being binary or ternary matrices; selecting one set of matrices from the sets of candidate matrices; determining system matrices used in a state equation for the system to be identified and system matrices used in an output equation for a system to be identified in response to the selected set of matrices; and evaluating whether the selected structure matrices are reasonable for identifying the system to be identified.

### Advantageous Effects of Invention

According to the present invention, it is possible to achieve system identification using previous knowledge.

### BRIEF DESCRIPTION OF DRAWINGS

FIG. 1 illustrates a relation of an input, an output, and a system state of a system to be identified;

FIG. 2A schematically illustrates a basic configuration of a system identification device according to a first example embodiment;

FIG. 2B schematically illustrates the configuration of a system identification device according to a first example embodiment in more detail;

FIG. 3 is a flowchart of an operation of the system identification device according to the first example embodiment, which illustrates a basic recursive operation for determination of a proper system structure and system parameters;

FIG. 4 illustrates an example of selection set of binary/ternary matrices characterizing assumed system structure topologies;

FIG. 5 schematically illustrates a system identification method with integration of matrix decomposition/factorization method;

FIG. 6 illustrates a model of a reservoir/tank system in a process industry or model for other phenomenon and partly unknown structural properties (flows) of the system; and

FIG. 7 schematically illustrates an example configuration of a computer implementing the system.

### DESCRIPTION OF EMBODIMENTS

Example embodiments of the present invention will be described below with reference to the drawings. In the drawings, the same elements are denoted by the same reference numerals, and thus a repeated description is omitted as needed.

### First Example Embodiment

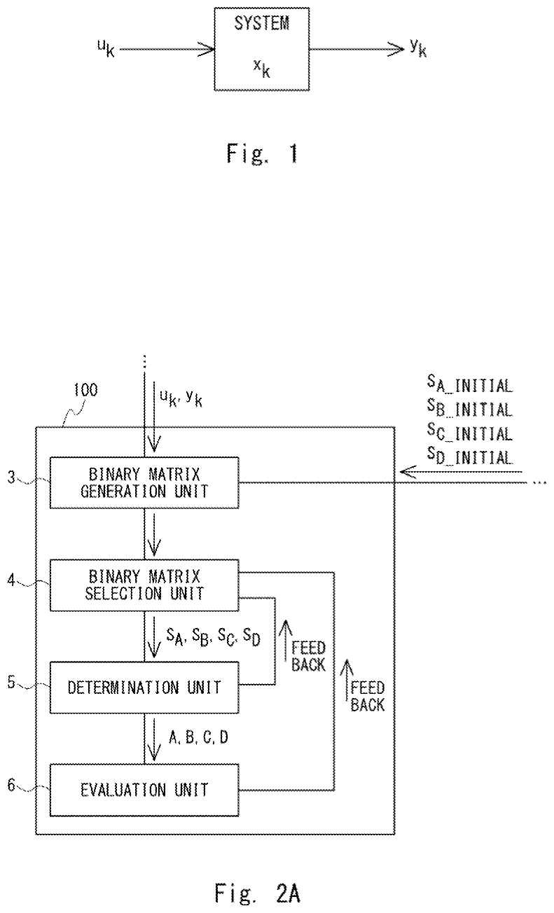

First, a principle of system identification will be described. FIG. 1 illustrates a relation of an input, an output, and a system to be identified. A state equation, an output equation and numerical algorithms are used for state space system identification. A common method for system identification is N4SID (Numerical algorithms for subspace state space system identification), which cannot directly integrate various structure assumptions for identification.

Here, k, which is an integer equal to or more than one, represents a discrete time variable. xₖ denotes a state variable or a state variable vector. yₖ denotes an output value or an output vector. uₖ is an input value or an input vector. For example, the state variable or the state variable vector represents a state of a target system for identification. The input value or the input vector represents input to the target system. The output value or the output vector represents output of the target system which is in the state and the input is given to the target system. Thus, a state equation of the system to be identified can be represented by the following expression, where A and B are system matrices and n_{pro,k} denotes a noise. The noise n_{pro,k} represents model error of the target system. The system state evolution can be compactly described as:

$$\begin{matrix}( Expression 1 ) & \\ {x}_{k + 1} = [ \begin{matrix}A & B\end{matrix} ] [ \begin{matrix}{x}_{k} \\ {u}_{k}\end{matrix} ] + {n}_{pro , k} . & [ 1 ]\end{matrix}$$

However, it is assumed that the noise n_{pro,k} is sufficiently small in comparison with xₖ, uₖ and the like and thereby the noise n_{pro,k} is neglected for simplicity in the present example embodiment, and the expression [1] can be converted into the expression [2].

$$\begin{matrix}( Expression 2 ) & \\ {x}_{k + 1} = [ \begin{matrix}A & B\end{matrix} ] [ \begin{matrix}{x}_{k} \\ {u}_{k}\end{matrix} ] = {Ax}_{k} + {Bu}_{k} & [ 2 ]\end{matrix}$$

An output equation of the system to be identified can be represented by the following expression [3], where C and D are system matrices and n_{mes,k} denotes measurement noise of the target system.

$$\begin{matrix}( Expression 3 ) & \\ {y}_{k} = [ C D ] [ \begin{matrix}{x}_{k} \\ {u}_{k}\end{matrix} ] + {n}_{mes , k} & [ 3 ]\end{matrix}$$

However, it is assumed that the noise n_{mes,k} is sufficiently small in comparison with xₖ, uₖ and the like and thereby the noise n_{mes,k} is neglected for simplicity in the present example embodiment, and the expression [3] can be converted into the expression [4].

$$\begin{matrix}( Expression 4 ) & \\ {y}_{k} = [ \begin{matrix}C & D\end{matrix} ] [ \begin{matrix}{x}_{k} \\ {u}_{k}\end{matrix} ] = {Cx}_{k} + {Du}_{k} & [ 4 ]\end{matrix}$$

The system matrices A, B, C, and D are assumed to be unknown. The only information available are binary/ternary structure matrices S_{A}, S_{B}, S_{C}, and S_{D} that include entries (0/1/*). Either S_{A}, S_{B}, S_{C}, and S_{D} are given or a set S={S1, S2, . . . } with the single tuples S1=(S_{A1}, S_{B1}, S_{C1}, and S_{D1}), S2=(S_{A2}, S_{B2}, S_{C2}, and S_{D2}), . . . are given. In the binary structure matrices S_{A}, S_{B}, S_{C}, and S_{D}, “0” represents that the entry is zero, and “1” represents that the entry has an arbitrary value. (or “0” represents that the entry is zero, “1” represents that the entry differs from zero, and “*” that the entry has an arbitrary value). Note that “*” in the structure matrix means that the entry in the structure matrix is 0 or 1, i.e. the corresponding entry in the system matrix is arbitrary.

In the present example embodiment, the system matrices A, B, C, and D are estimated by using the structure assumption S_{A}, S_{B}, S_{C}, and S_{D}. Algorithms that allow for the structure assumption to be integrated can be devised on a guideline according to the present example embodiment. Hereinafter, an operator “o” represents Hadamard multiplication between two matrices. The Hadamard product presentation can be used to mathematically describe the structure assumption:

(Expression 5)

A∘S_{A}=A [5]

(Expression 6)

B∘S_{B}=B [6]

(Expression 7)

C∘S_{C}=C [7]

(Expression 8)

D∘S_{D}=D [8].

In other words, the system matrices A, B, C, D are conditioned as far as their structure is concerned by the above conditions. [5] to [8].

The system matrices A, B, C, and D, and the binary structure matrices S_{A}, S_{B}, S_{C}, and S_{D} will be described with reference to an example. For example, the system matrices A, B, C, and D may be represented by the following expressions [9] to [12] (showing this particular structure).

$$\begin{matrix}( Expression 9 ) & \\ A = [ \begin{matrix}* & 0 & 0 \\ 0 & * & * \\ * & * & * \\ 0 & * & 0\end{matrix} ] & [ 9 ] \\ ( Expression 10 ) & \\ B = [ \begin{matrix}* & 0 \\ 0 & 0 \\ 0 & * \\ * & *\end{matrix} ] & [ 10 ] \\ ( Expression 11 ) & \\ C = [ \begin{matrix}* & 0 & 0 & * \\ 0 & * & * & 0 \\ * & 0 & * & *\end{matrix} ] & [ 11 ] \\ ( Expression 12 ) & \\ D = [ \begin{matrix}0 & * \\ * & * \\ * & 0\end{matrix} ] & [ 12 ]\end{matrix}$$

In this example, the binary structure matrices S_{A}, S_{B}, S_{C}, and S_{D} may be represented by the following expressions [13] to [16].

$$\begin{matrix}( Expression 13 ) & \\ {S}_{A} = [ \begin{matrix}1 & 0 & 0 \\ 0 & 1 & 1 \\ 1 & 1 & 1 \\ 0 & 1 & 0\end{matrix} ] & [ 13 ] \\ ( Expression 14 ) & \\ {S}_{B} = [ \begin{matrix}1 & 0 \\ 0 & 0 \\ 0 & 1 \\ 1 & 1\end{matrix} ] & [ 14 ] \\ ( Expression 15 ) & \\ {S}_{C} = [ \begin{matrix}1 & 0 & 0 & 1 \\ 0 & 1 & 1 & 0 \\ 1 & 0 & 1 & 1\end{matrix} ] & [ 15 ] \\ ( Expression 16 ) & \\ {S}_{D} = [ \begin{matrix}0 & 1 \\ 1 & 1 \\ 1 & 0\end{matrix} ] & [ 16 ]\end{matrix}$$

That is, the value “1” in the binary structure matrices S_{A}, S_{B}, S_{C}, and S_{D} corresponds to the an arbitrary value other than zero in the elements (or entries) in the system matrices A, B, C, and D that include the parameters of the target system.

Accordingly, the structure of the system matrices A, B, C, and D can be predetermined by the binary structure matrices S_{A}, S_{B}, S_{C}, and S_{D} that are provided in advance. The structure represents a structure of zero elements and non-zero elements in matrices.

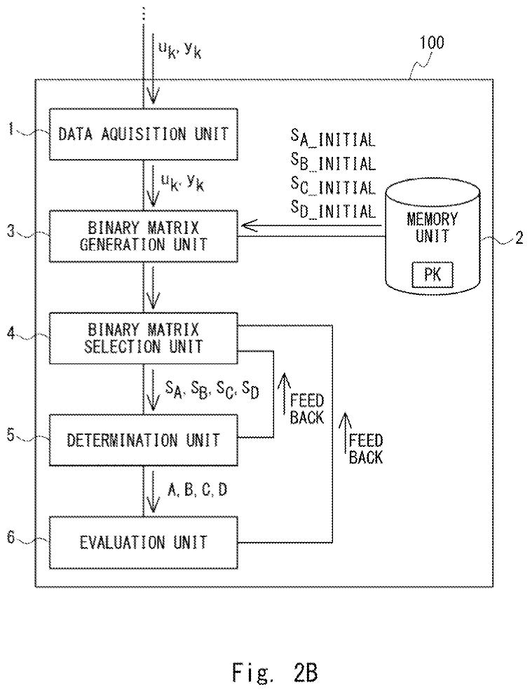

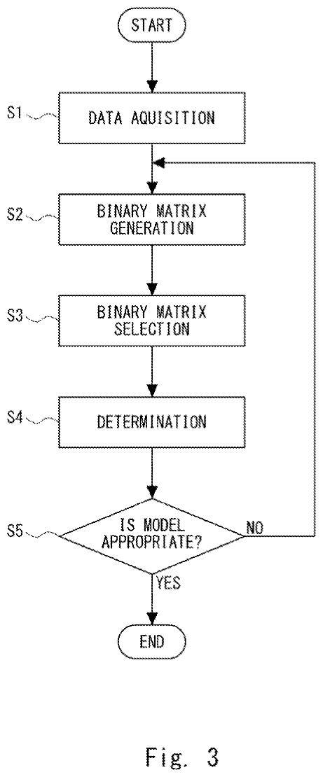

Subsequently, a system identification device according to a first example embodiment will be described. FIG. 2A schematically illustrates a basic configuration of a system identification device 100 according to the first example embodiment. FIG. 2B schematically illustrates the configuration of a system identification device 100 according to the first example embodiment more in detail. FIG. 3 is a flowchart of an operation of the system identification device 100 according to the first example embodiment, which illustrates a basic iterative operation for determination of a proper system structure and system parameters. The system identification device 100 includes a data acquisition unit 1, a memory unit 2, a binary matrix generation unit 3, a binary matrix selection unit 4, a determination unit 5, and an evaluation unit 6. It is important to mention that not only a single structure S1 can be used for identification but more than one, and based on the identification results improved structure suggestions generated.

### Step S1

The data acquisition unit 1 acquires the input values xₖ k=1 . . . N and the output values (a measurement value) yₖ. It is assumed that there is enough data available and the data shows enough variability to carry out the identification task.

### Step S2

The prior knowledge PK is stored in the memory unit 2. The prior knowledge PK includes initial binary structure matrices S_{A_INITIAL}, S_{B_INITIAL}, S_{C_INITIAL}, and S_{D_INITIAL} that are bases for generating the binary structure matrices S_{A}, S_{B}, S_{C}, and S_{D}. The initial binary structure matrices S_{A_INITIAL}, S_{B_INITIAL}, S_{C_INITIAL}, and S_{D}_INITIAL may not have the same structure of the structure matrices S_{An}, S_{Bn}, S_{Cn}, and S_{Dn}.

The binary matrix generation unit 3 generates a plurality of sets of candidate binary structure matrices S_{An}, S_{Bn}, S_{Cn}, and S_{Dn} from the initial binary structure matrices S_{A_INITIAL}, S_{B_INITIAL}, S_{C_INITIAL}, and S_{D_INITIAL}, where n is an integer equal to or more than one.

### Step S3

The binary matrix selection unit 4 selects the most appropriate matrices set from the n sets of candidate binary matrices and determine the selected set of candidate binary matrices as the binary structure matrices S_{A}, S_{B}, S_{C}, and S_{D} based on information provided by the user of the system identification device 100. A process of determining whether or not matrices are appropriate can be achieved by the following processing as shown in expressions [17] to [31].

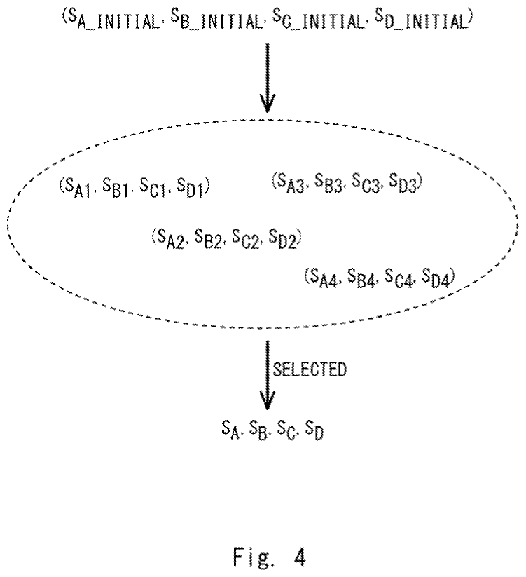

FIG. 4 illustrates an example of the selection of the binary/ternary matrices characterizing assumed system structure topologies. In FIG. 4, four sets of candidate binary structure matrices (S_{A1}, S_{B1}, S_{C1}, S_{D1}), (S_{A2}, S_{B2}, S_{C2}, S_{D2}), (S_{A3}, S_{B3}, S_{C3}, S_{D3}), and (S_{A4}, S_{B4}, S_{C4}, S_{D4}). The binary matrix selection unit 4 selects the most appropriate set from the four sets of candidate binary matrices and determine the selected set of candidate binary matrices as the binary structure matrices S_{A}, S_{B}, S_{C}, and S_{D}. The candidate binary matrices may have different structures with each other.

For example, the user can provide the memory unit 2 of the system identification device 100 with the information in advance. Further, this information includes some suggestions in the information based on the user's experience and/or preference.

The binary matrix selection unit 4 then evaluates whether the selected matrices set is appropriate. When the selected matrices set is appropriate, the process will be proceeded.

### Step S4

The determination unit 5 performs calculations for determining the binary system matrices A, B, C, and D. Based on the above expressions, yₖ may be represented by the following expression.

$$\begin{matrix}( Expression 17 ) & \\ {y}_{k} = [ \begin{matrix}CB & D\end{matrix} ] [ \begin{matrix}{u}_{k - 1} \\ {u}_{k}\end{matrix} ] + {CAx}_{k - 1} & [ 17 ]\end{matrix}$$

The matrix E=CB and the matrix D are determined by using the minimization criterion (basis for the devising of a concrete algorithm) as shown in the following expressions [18] to [20].

$$\begin{matrix}( Expression 18 ) & \\ {min}_{{B}^{′} , D} ‖ {y}_{k} - ( {Eu}_{k - 1} + {Du}_{k} ) ‖ & [ 18 ] \\ ( Expression 19 ) & \\ E • {S}_{CB} = E & [ 19 ] \\ ( Expression 20 ) & \\ {S}_{CB} = bin ( {S}_{C} {S}_{B} ) , & [ 20 ]\end{matrix}$$

where bin(.) is an operator that maps values greater than zero to one and zero values to zero values. Therefore, appropriate matrices can be selected from candidates of matrices based on errors between output values yₖ and estimation results calculated from the state values.

The current (newest) matrices D can be obtained or updated by using an algorithm that makes use of the Hadamard relation between the matrix D and the binary matrix S_{D} as represented by the following expression [21].

(Expression 21)

D∘S_{D}=D [21]

According to the expression [21] in this step, the matrix D can be determined.

In order to continue the identification algorithm, a part of the expression [18] will be defined as residual rₖ by the following expression.

(Expression 22)

rₖ=yₖ−(Euₖ₋₁+Duₖ) [22]

Next, the matrix E=CB is decomposed to obtain the matrices B and C by use of matrix factorization. This does not lead to a unique solution. However, the single solutions can be parametrized by a regular matrix.

The matrix B can be obtained or updated by matrix factorization using the Hadamard relation between the decomposed matrix B and the binary structure matrix S_{B} as represented by the following expression [23].

(Expression 23)

B∘S_{B}=B [23]

The same applies to the matrix C (matrix factorization using by using Hadamard relationship between the structured matrix C and the binary structure matrix S_{C} as represented by the following expression.

(Expression 24)

C∘S_{C}=C [24]

According to the expressions [23] and [24] in this step, the matrices B and C can be determined.

By combining the expressions [17], [22], and [23], the following expression may be established.

(Expression 25)

CAxₖ₋₁=rₖ [25]

By setting zₖ=Axₖ, the expressions [25] may be transformed into the following expression [26], where the Zₖ satisfies the expressions [27] to [29].

(Expression 26)

Czₖ₋₁=rₖ [26]

(Expression 27)

zₖ∘S_{z}_{ₖ}=zₖ [27]

(Expression 28)

Sₓ_{ₖ}=[1 . . . 1] [28]

(Expression 29)

S_{z}_{ₖ}=bin(S_{A}Sₓ_{ₖ}) [29]

By combining the expressions [2] and zₖ, the expressions [2] can be transformed into the following expression [30], where the matrix A satisfies the expression [31].

(Expression 30)

zₖ₊₁=A(zₖ+Buₖ) [30]

The current (newest) matrices A can be obtained by using Hadamard relationship between the decomposed matrix A and the binary structure matrix S_{A} as represented by the following expression and an appropriate method for separation [31].

(Expression 31)

A∘S_{A}=A [31]

If numeric problems are encountered during the calculation, the algorithm can be reinitialized with another parametrization of the relevant factorization.

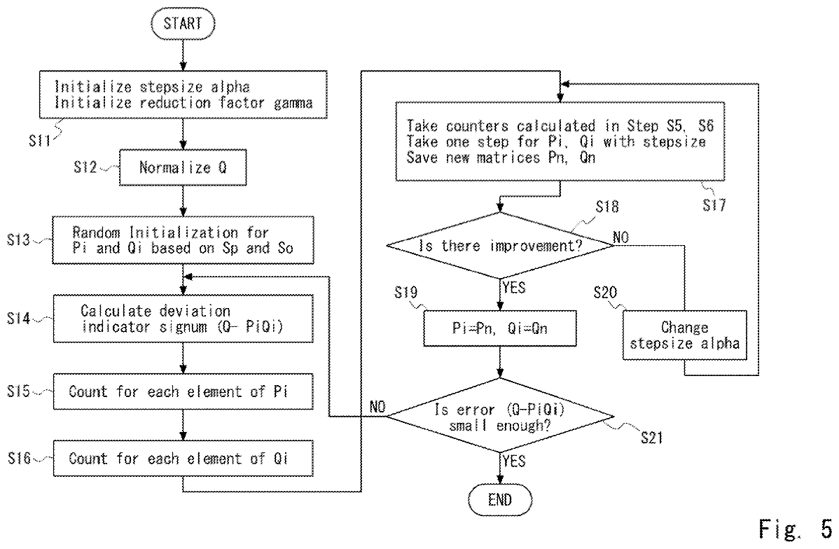

FIG. 5 schematically illustrates a system identification method with integration of matrix decomposition/factorization method. In FIG. 5, a decomposition algorithm is described for decomposing Q=OP with So, Sp known. It is based on normalizing Q, random initializing Oi, Pi and then comparing how close the products Oi, Pi comes to Q.

The improvements for each matrix element are derived from a counting scheme. For each element Oi,j and Pi,j it is counted how many products involved in the matrix row column type multiplication are increased (+1) and how many products involved are decreased (−1). This counter information is used to calculate updates with an appropriate step size. The algorithm has a good initial speed. It can be combined with other algorithms for decomposition (factorization).

The introduced matrix decomposition method by voting will be described in detail.

### Step S11

A step-size parameter alpha and a step-size variation factor gamma are set to appropriate values from experience.

### Step S12

Then, the matrix Q to be decomposed is normalized.

### Step S13

Random matrices Pᵢ=P₀, Qᵢ=Q₀ (normalized) are generated based on So, Sp.

### Step S14

Since they are generated randomly, the product P0Q0 does not equal to Q (normalized). Therefore, a deviation matrix is calculated and a signum-function is applied to the term Q−PᵢQᵢ.

This binary matrix is used for calculation of how many multiplies of the step-size parameter alpha is added to each element of the two matrices. The concrete determination is as following steps S5 and S6.

### Steps S15, S16

Since matrix multiplication is a type of row-column multiplication, it is separately counted how many times an entry of matrix is increased (+1) since it is part of a product which is part of a sum that is increased (can be determined from the entries of the aforementioned signum matrix). Likewise, it is counted how many times an entry of a matrix is decreased (−1) since it is part of a product which is part of a sum that is decreased (can be determined from the entries of the aforementioned signum matrix).

### Step S17

These counters for each of the elements of the two matrices are multiplied by the step-size and used as gradients to improve the two matrices Pi,Qi.

### Step S18

The product of the two new matrices is calculated, it is determined whether there is an improvement—meaning that the product is closer to the matrix Q.

### Step S19

When there is the improvement, the new matrices are kept.

### Step S20

Otherwise, the step size is changed (reduced by step variation factor gamma) and the process will be back to the step S17.

### Step S21

The product of the two matrices Pi,Qi is close enough to the matrix Q, then the calculation is stopped. Before the result can be used it has to be rescaled, since we used normalized versions of the matrices in the whole computation.

If the product of the two matrices is closer to the matrix Q, but still the difference not satisfactorily small enough, then the next computation is initiated. It starts with calculating the deviation and taking applying the signum function to each element of the matrix (deviation indicator) (Back to the step S14). Then the next steps (the step S14-) are taken as described before.

### Step S5

The evaluation unit 6 evaluates whether the obtained model, which is the current matrices A, B, C, and D, is appropriate for identifying the system to be identified. For example, the evaluation unit 6 can create a model structure using the parameters in the current matrices A, B, C, and D and a threshold and compare the created model structure and plausible (from the previous knowledge) structure of the system to be identified. Further, for example, the evaluation unit 6 can compare the created model structure with various limitations or criteria according to user's expertise.

When the obtained model is reasonable, the identification process will be finished. On the other hand, when the obtained model is not reasonable, the identification process will be back to the step S2.

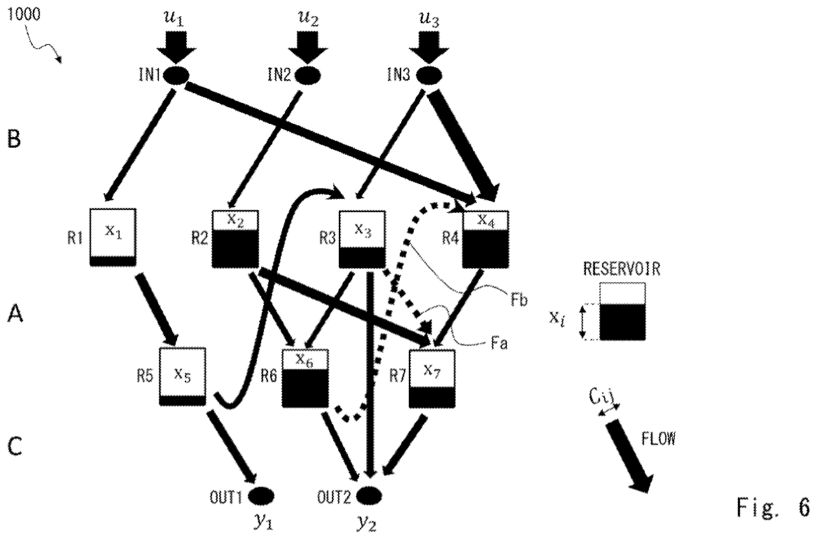

Next, the application of the system identification device 100 will be described. Here, the system identification device 100 will be applied to a reservoir/tank system (It could also be a medical body). FIG. 6 illustrates a model of the reservoir/tank system in a process industry or model for other phenomenon and partly unknown structural properties (flows) of the system. The flow system includes three inputs IN1 to IN3, two outputs OUT1 and OUT2, and seven reservoirs R1 to R7. In this case, states (levels) of the reservoirs R1 to R7 are represented by x₁ₖ to x₇ₖ, respectively. Therefore, i of the xᵢₖ can specify one of the reservoirs R1 to R7.

The input flow u₁ to u₃ are supplied to the inputs IN1 to IN3, respectively. The input u₁ is branched into two flows at the input IN1, and one flow is supplied to the reservoir R1 and the other flow is supplied to the reservoir R4. The input u₂ is supplied to the reservoir R2 through the input IN2. The input u₃ is branched into two flows at the input IN3, and one flow is supplied to the reservoir R3 and the other flow is supplied to the reservoir R4.

The output flow of the reservoir R1 is supplied to the reservoir R5. The output flow of the reservoir R2 is branched into two flows and one flow is supplied to the reservoir R6 and the other flow is supplied to the reservoir R7. The output flow of the reservoir R3 is branched into at least two flows and a first flow is supplied to the reservoir R6 and a second flow is supplied to the output OUT2. The output flow of the reservoir R4 is supplied to the reservoir R7.

The output flow of the reservoir R5 is branched into two flows and one flow is supplied to the output OUT1 and the other flow is supplied to the reservoir R3. The output flow of the reservoir R6 is supplied to at least the output OUT2. The output flow of the reservoir R7 is supplied to at least the output OUT2.

A conductivity parameter (a flow rate) of the flow is represented Cᵢⱼ, where j is a parameter for specifying the flow. In this case, since the maximum number of flows from one reservoir or one input, j is an integer from 1 to 3.

The output flow y₁ and y₂ flow out from the outputs OUT1 and OUT2, respectively.

However, in the model it is not sure whether there are a flow path Fa from the reservoir R3 to the reservoir R7 and/or a flow path Fb from the reservoir R6 to the reservoir R6.

According to this model, the initial binary structure matrix S_{A_INITIAL}, S_{B_INITIAL}, S_{C_INITIAL}, and S_{D_INITIAL} can be represented by the following expressions. Existence of the flow path Fa and Fb are reflected to the initial binary structure matrix S_{A_INITIAL} as in the expression [32] (0 or 1).

$$\begin{matrix}( Expression 32 ) & \\ {S}_{A\_INITIAL} = [ \begin{matrix}1 & 0 & 0 & 0 & 0 & 0 & 1 \\ 0 & 0 & 0 & 1 & 0 & 0 & 0 \\ 0 & 0 & 0 & 0 & 0 & 1 & 0 \\ 0 & 0 & 0 & 1 & 0 & 0 & 0 \\ 0 & 0 & 0 & 0 or 1 & 0 & 0 & 0 \\ 0 & 0 & 0 & 0 & 0 & 1 & 0 \\ 0 & 0 & 0 or 1 & 0 & 0 & 0 & 0\end{matrix} ] & [ 32 ] \\ ( Expression 33 ) & \\ {S}_{B\_INITIAL} = [ \begin{matrix}1 & 0 & 0 \\ 0 & 1 & 0 \\ 0 & 0 & 1 \\ 1 & 0 & 1 \\ 0 & 0 & 0 \\ 0 & 0 & 0 \\ 0 & 0 & 0\end{matrix} ] & [ 33 ] \\ ( Expression 34 ) & \\ {S}_{C\_INITIAL} = [ \begin{matrix}0 & 0 & 0 & 0 & 1 & 0 & 0 \\ 0 & 0 & 1 & 0 & 0 & 1 & 1\end{matrix} ] & [ 34 ] \\ ( Expression 35 ) & \\ {S}_{D\_INITIAL} = [ \begin{matrix}0 & 0 & 0 \\ 0 & 0 & 0\end{matrix} ] & [ 35 ]\end{matrix}$$

As described above, according to the configuration, it is possible to identify the system using an algorithm based on the identification method proposed here using the prior knowledge.

### Other Example Embodiments

Note that the present invention is not limited to the above example embodiments and can be modified as appropriate without departing from the scope of the invention. For example, in the above example embodiments, the present invention is described as a hardware configuration, but the operations of the data acquisition unit 1, the binary matrix generation unit 3, the binary matrix selection unit 4, the determination unit 5, and the evaluation unit 6 can be implemented by causing a CPU (Central Processing Unit) to execute a computer program. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

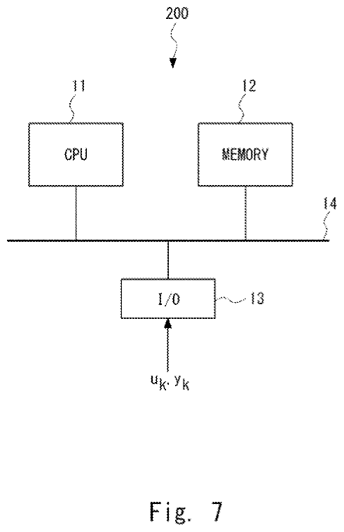

An example configuration of the computer will be described. FIG. 7 schematically illustrates an example configuration of the computer 200 implementing the system 1000. In this case, the computer 200 includes a CPU 11, a memory 12, an input/output interface (I/O) 13 and a bus 14. The CPU 11, the memory 12 and the input/output interface (I/O) 13 can communicate each other via the bus 14. The CPU 11 achieves functions of the data acquisition unit 1, the binary matrix generation unit 3, the binary matrix selection unit 4, the determination unit 5, and the evaluation unit 6 by executing the program. The memory 22 corresponds to the memory unit 2 described above. The input/output interface (I/O) 23 receives the input uₖ and the output yₖ from an external memory device, an external measurement device, or the like. The program can be stored in the memory 12 and be read out and executed by the CPU 11 as appropriate.

While the present invention has been described above with reference to example embodiments, the present invention is not limited to the above example embodiments. The configuration and details of the present invention can be modified in various ways which can be understood by those skilled in the art within the scope of the invention.

### REFERENCE SIGNS LIST

1 DATA ACQUISITION UNIT
2 MEMORY UNIT
3 BINARY MATRIX GENERATION UNIT
4 BINARY MATRIX SELECTION UNIT
5 DETERMINATION UNIT
6 EVALUATION UNIT
11 CPU
12 MEMORY
13 INPUT/OUTPUT INTERFACE (I/O)
14 BUS
100 SYSTEM IDENTIFICATION DEVICE
200 COMPUTER
1000 MODEL OF FLOW SYSTEM.
IN1 TO IN3 INPUTS
R1 TO R7 RESERVOIRS
OUT1, OUT2 OUTPUTS

What is claimed is:

1. A system identification device comprising:
a structure matrix generation unit configured to read initial structure matrices obtained from prior knowledge and generate a plurality of sets of candidate structure matrices, the initial structure matrices being binary or ternary matrices;
a matrix selection unit configured to select one set of matrices from the sets of candidate structure matrices;
a determination unit configured to determine matrices used in a state equation for a system to be identified and matrices used in an output equation for the system to be identified in response to the selected set of structure matrices; and
an evaluation unit configured to evaluate whether the selected structure matrices are reasonable for identifying the system to be identified.

2. The system identification device according to claim 1, wherein
the state equation is represented by the following expression
$$\begin{matrix}( Expression 1 ) & \\ {x}_{k + 1} = [ \begin{matrix}A & B\end{matrix} ] [ \begin{matrix}{x}_{k} \\ {u}_{k}\end{matrix} ] = {Ax}_{k} + {Bu}_{k} & [ 1 ]\end{matrix}$$
where k is a discrete time variable that is an integer equal to or more than one, xₖ denotes a state variable or a state variable vector, yₖ denotes an output of the system to be identified and yₖ is a value or a vector, uₖ is an input of the system to be identified and uₖ is a value or a vector, and A and B are system matrices,
the output equation is represented by the following expression
$$\begin{matrix}( Expression 2 ) & \\ {y}_{k} = [ \begin{matrix}C & D\end{matrix} ] [ \begin{matrix}{x}_{k} \\ {u}_{k}\end{matrix} ] = {Cx}_{k} + {Du}_{k} & [ 2 ]\end{matrix}$$
where yₖ denotes the output of the system to be identified and yₖ is a value or a vector, and C and D are system matrices, and
the determination unit calculations are based on a special identification method which makes use of matrix factorization in order to fulfill the Hadamard products identity of the system matrices A, B, C, and D at the time variable k and the selected structure matrices S_{A}, S_{B}, S_{C}, and S_{D} to generate the system matrices A, B, C, and D at the time variable k+1 as expressed by the following expressions
(Expression 3)
A∘S_{A}=A [3]
(Expression 4)
B∘S_{B}=B [4]
(Expression 5)
C∘S_{C}=C [5]
(Expression 6)
D∘S_{D}=D [6],
where the operator “o” is a Hadamard multiplication operator.

3. The system identification device according to claim 1, wherein
the system matrix D is determined using the following expressions
$$\begin{matrix}( Expression 7 ) & \\ {y}_{k} = [ \begin{matrix}CB & D\end{matrix} ] [ \begin{matrix}{u}_{k - 1} \\ {u}_{k}\end{matrix} ] + {CAx}_{k - 1} + {Cn}_{pro , k - 1} + {n}_{mes , k - 1} & [ 7 ] \\ ( Expression 8 ) & \\ {min}_{{B}^{′} , D} ‖ {y}_{k} - ( {Eu}_{k - 1} + {Du}_{k} ) ‖ & [ 8 ] \\ ( Expression 9 ) & \\ E • {S}_{CB} = E & [ 9 ] \\ ( Expression 10 ) & \\ {S}_{CB} = bin ( {S}_{C} {S}_{B} ) , & [ 10 ]\end{matrix}$$
the matrix E is decomposed into the system matrices B and C, and the system matrices B and C are determined by the following expressions
(Expression 11)
B∘S_{B}=B [11]
(Expression 12)
C∘S_{C}=C [12],
and
the system matrix A is determined by the following expressions
(Expression 13)
rₖ=yₖ−(Euₖ₋₁+Duₖ) [13]
(Expression 14)
CAxₖ₋₁=Czₖ₋₁=rₖ [14]
(Expression 15)
zₖ∘S_{z}_{ₖ}=zₖ [15]
(Expression 16)
Sₓ_{ₖ}=[1 . . . 1]^{T} [16]
(Expression 17)
S_{z}_{ₖ}=bin(S_{A}Sₓ_{ₖ}) [17].

4. The system identification device according to claim 3, wherein the matrix is factorized by using decomposition Q=OP with So, Sp method based on counting how many products need to be increased and how many products need to be decreased for improving the approximation matrices.

5. The system identification device according to claim 1, further comprising:
a data acquisition unit configured to acquire input data and output data of a system to be identified; and
a memory unit configured to store the initial structure matrices.

6. A non-transitory computer readable medium storing a system identification program, the system identification program causing a computer to execute:
a process of reading initial structure matrices obtained from prior knowledge and generating a plurality of sets of candidate structure matrices, the initial structure matrices being binary or ternary matrices;
a process of selecting one set of matrices from the sets of candidate structure matrices;
a process of determining structure matrices used in a state equation for the system to be identified and matrices used in an output equation for a system to be identified in response to the selected set of matrices; and
a process of evaluating whether the selected structure matrices are reasonable for identifying the system to be identified.

7. A system identification method comprising:
reading initial structure matrices obtained from prior knowledge and generating a plurality of sets of candidate matrices, the initial structure matrices being binary or ternary matrices;
selecting one set of matrices from the sets of candidate matrices;
determining system matrices used in a state equation for the system to be identified and system matrices used in an output equation for a system to be identified in response to the selected set of matrices; and
evaluating whether the selected structure matrices are reasonable for identifying the system to be identified.
